(19) United States
(12) Patent Application Publication
(10) Pub. No.: US 2009/0188788 A1
(43) Pub. Date: Jul. 30, 2009

(54) Method for Chlorinating Water by Electrolysis and/or Light Projection for Pool Operating with Mechanical Energy of the Delivery Nozzle

(76) Inventors: Jacques-Alexandre Habif, Garches (FR); Marc Idoine, Chassemy (FR)

Correspondence Address: STURM & FIX LLP, 206 SIXTH AVENUE, SUITE 1213, DES MOINES, IA, 50309-4076, US

(21) Appl. No.: 11/996,200

(22) PCT Filed: Jul. 20, 2006
(86) PCT No.: PCT/FR2006/001781

§ 371 Date: May 22, 2008

(30) Foreign Application Priority Data
Jul. 20, 2005 (FR) 0507715

(51) Int. Cl. C02F 1/461; C02F 103/42

(52) U.S. Cl. 204/228.3

(57) ABSTRACT

The invention concerns a system for chlorinating water by electrolysis and/or light projection for pool operating with mechanical energy of the delivery nozzle. The invention concerns a system for chlorinating water by electrolysis and illumination of pools provided with a water circulating system. The system is easily set on the entire pool without affecting its sealed character and uses a free and safe source of energy, the motive power of the water from the delivery nozzle, the device consisting of a hollow single-unit assembly (1), connected to the delivery nozzle, allowing the water flow to circulate in controlled manner actuating a device with rotational movement (8) connected to a current generator (9) which powers, with variable intensity, alternately or jointly, the sealed light projector (11) and/or the electrolytic cell (12) before exiting into the pool. The inventive device is particularly designed to illuminate and/or chlorinate water of swimming pools.

This invention relates to a water electrolytic cell and/or a watertight illuminator system for swimming pools, comprising a water circulation system, configured as a submerged or semi-submerged device fed by the water discharge into in the pool.

The water electrolysis allows the obtaining of the chlorine necessary for the purification of the water and the salt added to the water. The lighting of pools, on the one hand, and the electrolysis of the water constituting one of the means for the chlorination, on the other hand, are traditionally performed by different means, each of which is fed by an electric source either connected to the electric network or being battery operated.

However, the existing systems have several disadvantages. First, the existing systems have the disadvantage that they require different devices for the obtaining of pool illumination and for the actuating of a water electrolytic system. Second, the illuminator devices and the water electrolytic systems have the disadvantage that they cannot be applied to any type of pool, be it because of lacking a supporting point, be it because of the impossibility of performing an opening in the pool wall for the installation, or be it because of the complexity associated with the necessary wiring in the case of a connection to the electric network. Third, the existing systems have the disadvantage that they must necessarily be supplied with electric power from the electric network or from a battery, which could create a potential danger to the possible bathers, not allowing them to be under water because of the risk of the motor, and it also entails operating costs.

The device according to the invention remedies these disadvantages. First and foremost, it allows it to be connected and added—be it submerged or semi-submerged—to any type of pool, provided with a water circulation system, because of having to be connected only to the water discharge nozzle without any other feed source than the mechanical force of the water the output of which is measured by a control valve, either manual or connected to the control box. Second, the device according to the invention provides a perfect water tightness of the pool wall since no opening has to be performed in it to install the illuminator or the water electrolytic system that is connected only to the discharge nozzle. Third, the device according to the invention operates thanks only to the driving force of the water being discharged from the discharge nozzle to which it is connected, which can give a feeling of complete security to the bathers and to function without electric wirings, while allowing to measure the intensity of the illuminator and/or to dose the water chlorination according to the voltage generated by the flow of water controlled by the position of the control valve, either manual or connected to the control box. Fourth, the device according to the invention allows the obtaining of energy saving for society as well as financial savings for the user due to using the free-of-charge energy source generated by the mechanical force of the water discharged by the discharge nozzle. Fifth, the device according to the invention offers the possibility to obtain by means of the same device, either alternatively or jointly depending on the control box, an illuminator and a water electrolytic system, while allowing a chlorination that facilitates a financial saving associated with the purchase of less material as well as space saving.

Thus, the invention consists in a water electrolytic cell for pools and/or a watertight illuminator for a swimming pool, arranged either separated or jointly in a hollow single unit assembly connected by means of a connector ring to the discharge nozzle for the water in the swimming pool and placed either submerged or semi-submerged in said pool, through which nozzle the entering water flow is driven by the discharge nozzle to a first channel—depending on an output measured by a control valve, be it manual or connected to the control box, that can be provided with a variator controlling the degree of opening—and is immediately discharged into the pool by an opening on the top, in an inactive or less intensive position of the system when the control valve, be it manual or connected to a control box, suitable to be provided with a variator controlling the degree of opening, fully or partially open and, when the system is active and the fully or partially closed control valve is directed towards a second channel in which it actuates a rotary movement device connected to the current generator that feeds the watertight illuminator and/or the electrolytic cell—joined or not in the same single-unit assembly and arranged either together or separately in the second channel—each of which is connected to the current generator, either directly or via a control box, being provided with a circuit breaker and/or a variator and/or an alternative control, the feed being made alternatively or jointly and at variable intensity, depending, on the one hand, on the degree of opening of the control valve which, in turn, depends on the desired illumination and/or chlorination and controlling the start-up or the shut-down of the system and, on the other hand, on the choice of activating the watertight illuminator and/or the electrolytic cell; each of these two actions can be controlled, either individually or jointly, by the control box that connects the generator to the watertight illuminator or to the electrolytic cell and/or to the control valve, before the flow of water enters into the pool by an opening at the bottom from which the electrolysis of the water, releasing the chlorine, is effectuated when the electrolytic cell is activated, and salt is added by the user to the pool water.

The hereto annexed drawing illustrates the invention:

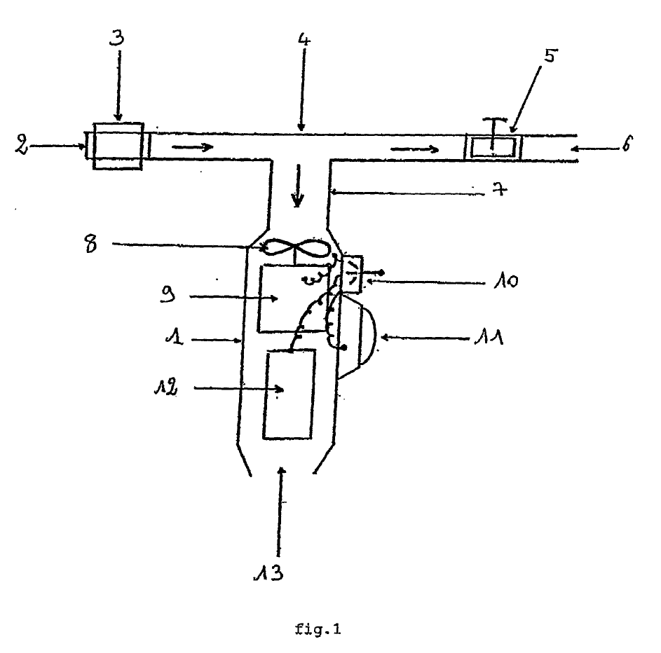

FIG. 1 is a cross-section of an embodiment of the internal arrangement of the invention.

With respect to this drawing, the device, constituted by a hollow single-piece assembly (1), placed in the water of the pool—either submerged or semi-submerged—connected to the discharge nozzle at the inlet of the flow (2), comprises in the direction of the flow a connector ring (3), a first channel (4) provided with a control valve (5) that allows to totally or partially close an opening at the top (6) through which the water is discharged either in an inactive manner or less intense, a second channel (7) in which the water circulates in an activated manner when the control valve (5) is totally or partially closed, which activates the rotary movement device (8) connected to the current generator (9) that feeds in the second channel (7) the watertight illuminator (11) and/or the electrolytic cell (12) that are connected by means of a control box (10) provided with a circuit breaker and an alternate control with a variable intensity and, alternatively or jointly, depending on the position of the control valve (5) and on the choice of activating the watertight illuminator (11) and/or the electrolytic cell (12) before the water flow enters into the pool through an opening at the bottom (13) from which, when the electrolytic cell is activated, is effectuated the electrolysis of the water releasing the chlorine and the salt added by the user in the water of the pool

By way of a non limiting example, the submerged or semi-submerged single-unit assembly has a height of about 60 centimeters, a width of about 50 centimeters and a diameter of 20 centimeters.

The device according to the invention is particularly suitable for back-up illumination of pools and swimming-pool water chlorinating by electrolysis.

1) A system of a swimming-pool water electrolytic cell and/or a watertight illuminator for a swimming pool, arranged either separated or jointly in a hollow single unit assembly (1), placed in the pool water, connected by means of a connector ring (3) to the discharge nozzle for the water in the swimming pool through which nozzle the entering water flow (2) is driven by the discharge nozzle to a first channel (4)—depending on an output measured by a control valve (5)—and is immediately discharged into the pool by an opening on the top (6), in an inactive or less intensive position of the system when the control valve (5) is fully or partially open and, when the system is active and the fully or partially closed control valve (5) is directed towards a second channel (7) in which it actuates a rotary movement device (8) connected to the current generator (9) that feeds the watertight illuminator (11) and the electrolytic cell (12) arranged together in the second channel (7), each of which is connected to the current generator (9) by means of a control box that is provided with a circuit breaker and an alternative control, the feed being made alternatively or jointly and at a variable intensity, depending, on the one hand, on the degree of opening of the control valve (5) depending on the desired illumination and/or chlorination and controlling the start-up or the shut-down of the system and, on the other hand, on the choice of activating the watertight illuminator and/or the electrolytic cell, being this action controlled by the control box that connects the generator (9) to the watertight illuminator (11) and to the electrolytic cell (12) and before the flow of water enters into the pool by an opening at the bottom (13) from which the electrolysis of the water, releasing the chlorine, effectuated when the electrolytic cell is activated, and the salt added by the user to the pool water.

2) A device according to claim 1, characterized in that the hollow singly-unit assembly (1) is submerged.

3) A device according to claim 1, characterized in that the hollow single-unit assembly (1) is semi-submerged.

4) A device according to any of above claims, characterized in that the control valve (5) is manual.

5) A device according to either claim 1, 2 or 3, characterized in that the control valve (5) is connected to the control box (10), provided with a variator that controls the degree of opening.
